(19) United States
(12) Patent Application Publication
(10) Pub. No.: US 2011/0221389 A1
(43) Pub. Date: Sep. 15, 2011

(54) WIRELESS POWER CHARGING METHOD AND APPARATUS FOR ELECTRONIC DEVICE

(75) Inventors: Eun-Tae WON, Seoul (KR); Seung-Hoon Park, Seoul (KR); Joon-Ho Park, Seongnam-si (KR); Jun-Ho Koh, Suwon-si (KR); Hee-Won Jung, Suwon-si (KR); Jae-Seung Son, Suwon-si (KR)

(73) Assignee: Samsung Electronics Co., Ltd., Suwon-si (KR)

(21) Appl. No.: 13/047,314

(22) Filed: Mar. 14, 2011

(30) Foreign Application Priority Data
Mar. 12, 2010 (KR) 10-2010-0022518
Jul. 16, 2010 (KR) 10-2010-0068923

(51) Int. Cl. H02J 7/00

(52) U.S. Cl. 320/108

(57) ABSTRACT

A bidirectional wireless charging method includes performing a mode change to a requesting electronic device if charging is necessary, requesting charging from at least one electronic device, receiving status information from the at least one electronic device that has received the charging request, selecting the electronic device based on the status information, and performing charging by receiving power supplied from the selected at least one electronic device.

### PRIORITY

This application claims priority under 35 U.S.C. §119(a) to applications entitled “Wireless Power Charging Method And Apparatus For Electronic Device” filed in the Korean Intellectual Property Office on Mar. 12 & Jul. 16, 2010 and assigned Serial Nos. 10-2010-0022518 & 10-2010-0068923, respectively, the entire disclosure of which is incorporated herein by reference.

### BACKGROUND OF THE INVENTION

1. Field of the Invention

The present invention relates generally to wireless charging of electronic devices, and more particularly to a method and apparatus for performing wireless charging between electronic devices using near field communication.

2. Description of the Related Art

A mobile terminal, such as a portable phone, a PDA (Personal Digital Assistant), or the like, is powered by a rechargeable battery, and in order to charge such a battery, electric energy is supplied to the battery of the mobile terminal using a separate charging device. Typically, the charging device and the battery are provided with separate contact terminals, where the charging device and the battery are electrically connected through the contact terminals.

However, one problem with such contact type charging systems is that the externally projected contact terminals are easily contaminated by foreign substances, or even moisture, which impede proper battery charging.

In order to solve this problem, a wireless charging or non-contact charging technology has been recently developed and used in many electronic devices.

Such wireless charging technology uses wireless power transmission and reception, and one example is a system which can automatically charge a battery that is put on a charging pad without connecting a separate charging connector to a portable phone. Generally known examples include wireless electric toothbrushes or wireless shavers. Such wireless charging technology can improve the waterproof function by wirelessly charging the electronic device, and improve the portability of the electronic device since it does not require a wired charger. It is expected that related technologies will be developed in the forthcoming generation of electric cars.

The wireless charging technology, is generally classified into electromagnetic induction types using a coil, types using resonance, and Radio Frequency (RF) or microwave radiation types converting electric energy into a microwave to transfer the power, and the like.

Until now, the electromagnetic induction type power charging technology has been the mainstream, but recently, experiments in which the power is wirelessly transmitted within several tens of meters using microwaves have been successful domestically and abroad, and thus it is expected that all electronic devices will be capable of wirelessly charging anywhere and anytime in the near future.

The electromagnetic induction type power transmission is a type that transmits power between a primary coil and a secondary coil using a property in that a current is induced through the movement of a magnet against a coil to generate the electricity, and using this, a transmitting end generates a magnetic field, and a receiving end serves as a magnet to produce energy. This phenomenon is called a magnetic induction phenomenon, and the power transmission method using this phenomenon has excellent energy transmission efficiency.

The electromagnetic induction type has been widely commercialized and applied to diverse devices. The wireless non-contact charging technologies in the related art mostly adopt the electromagnetic induction type, and have been applied to electric shavers, electric toothbrushes, and the like, using nickel batteries.

The resonance type is a type using the resonance characteristics of an electromagnetic wave. In 2005, Professor Soljacic of MIT published a system for wirelessly transferring the electricity from a charging device that is several meters apart from a device to be charged using a resonance type power transmission principle (corresponding to a coupled mode theory). The physical concept of resonance using a tuning fork was used in the wireless charging system of the MIT research team. The research team made an electromagnetic wave that carries the electric energy resonate rather than sound. Since this resonating electromagnetic wave is directly transferred only where a device having the resonance frequency exists and a portion that is not in use is reabsorbed into the electromagnetic field instead of spreading in the air, it is expected that the resonating electromagnetic wave will exert no influence on surrounding machines or human bodies, unlike other electromagnetic waves.

The RF/microwave radiation type is a new power transmission type that transfers energy through a conversion of the power energy into a microwave that is favorable to the wireless transmission. The power transmission is to transmit the electric energy rather than a signal that is used in a wireless communication type such as a radio receiver, a wireless phone, or the like. That is, whereas typical communication is to transmit a signal that is carried on a carrier signal, the wireless power transmission is to transmit only the carrier.

The wireless charging technology in the related art is limitedly applied to wireless electric toothbrushes or wireless shavers. Recently, much research has been made to develop resonance types and to introduce the wireless charging technology into a portable phone and a TV. Accordingly, a method for aiding mutual power charging between devices that can supply and demand the power, if necessary, has been researched.

### SUMMARY OF THE INVENTION

Accordingly, the present invention has been made to solve the above-mentioned problems occurring in the prior art. The present invention provides a wireless charging method and apparatus which can perform wireless charging between electronic devices.

In accordance with an aspect of the present invention, there is provided a bidirectional wireless charging method, which includes performing a mode change to a requesting electronic device if charging is necessary; requesting charging from at least one electronic device; receiving status information from the at least one electronic device that has received the charging request; selecting the electronic device based on the status information; and performing charging by receiving power supplied from the selected at least one electronic device.

The bidirectional wireless charging method according to an embodiment of the present invention may further include transmitting charging result information to a server if wireless charging is completed. In accordance with another aspect of the present invention, there is provided a bidirectional wireless charging method, which includes performing a mode change to a supply electronic device if a charging request is received; transmitting status information to an electronic device that has requested the charging; and performing charging by supplying power to the electronic device that has requested the charging.

The bidirectional wireless charging method according to another embodiment of the present invention may further include transmitting a message for reporting cancellation of the wireless charging session and charging result information to a server if the charging session is canceled before wireless charging is completed.

In accordance with still another aspect of the present invention, there is provided a bidirectional wireless charging apparatus, which includes a wireless charging unit performing wireless charging; a wireless communication unit performing near field communication; a display unit displaying a charging state during wireless charging; an input unit receiving a user input; and a control unit performing a mode change to a requesting electronic device if charging is necessary, requesting charging from at least one electronic device, receiving status information from the at least one electronic device that has received the charging request, selecting the electronic device based on the status information, and performing charging by receiving power supplied from the selected at least one electronic device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating the configuration of a wireless charging system for an electronic device according to an embodiment of the present invention;

FIGS. 2A and 2B are diagrams illustrating the configuration of an electronic device that can perform wireless charging according to an embodiment of the present invention;

FIG. 3 is a diagram illustrating an operational flow of a charging request device during a wireless charging operation of a wireless communication device according to an embodiment of the present invention;

FIG. 4 is a diagram briefly illustrating a power request operation performed by a wireless communication device that is low on power during a wireless charging operation of a wireless communication device according to an embodiment of the present invention;

FIG. 5 is a diagram briefly illustrating an operation of receiving a response message to a power request during a wireless charging operation of a wireless communication device according to an embodiment of the present invention;

FIG. 6 is a diagram briefly illustrating an operation of transmitting a wireless charging result during a wireless charging operation of a wireless communication device according to an embodiment of the present invention;

FIG. 7 is a diagram illustrating an operational flow of a charging providing device during a wireless charging operation of a wireless communication device according to an embodiment of the present invention; and

FIG. 8 is a diagram illustrating an operational flow of a server during a wireless charging operation of a wireless communication device according to an embodiment of the present invention;

### DETAILED DESCRIPTION OF EMBODIMENTS OF THE PRESENT INVENTION

Hereinafter, embodiments of the present invention will be described with reference to the accompanying drawings. In the following description, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention provides a wireless charging method and apparatus between electronic devices that can perform wireless communication with each other.

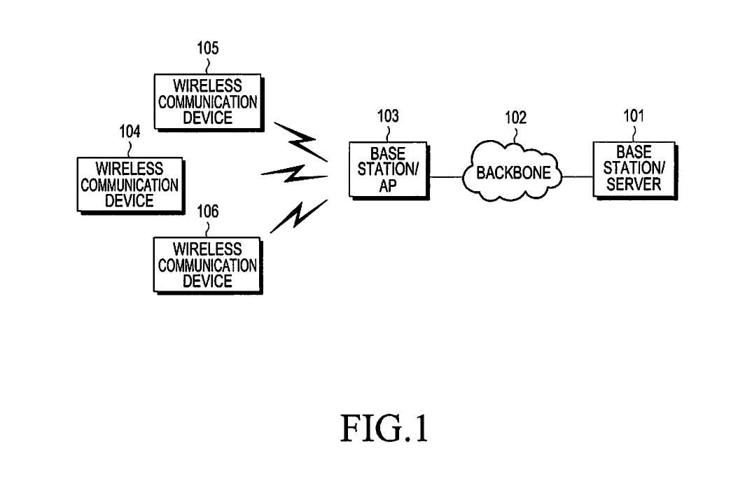

FIG. 1 is a diagram illustrating the configuration of a wireless charging system for an electronic device according to an embodiment of the present invention.

Referring to FIG. 1, a wireless charging system for an electronic device according to an embodiment of the present invention includes wireless communication devices 104, 105, and 106 that can perform wireless charging, a base station server 101 for managing communication between the respective wireless communication devices 104, 105, and 106 and billing information, a backbone 102 that is a network connecting a base station/AP 103 with the base station server 101, and the base station/AP 103 connecting the wireless communication devices 104, 105, and 106 and the backbone.

The base station/AP 103 can perform a function of an Access Point (AP) where near field communication (ZigBee, Bluetooth®, WiFi, UWM, or the like) modem is mounted thereon.

In FIG. 1, wireless communication devices are exemplified as electronic devices that can perform wireless charging. However, all electronic devices that can supply and receive wireless power can be used as the electronic devices. For example, 3D glasses, a mobile PC, an electric car, a subway, and the like, may be the electronic devices that can perform wireless charging. Also, the electronic device for providing the power may be an electronic device such as a power station that is installed in a specified area to provide the power to the neighboring wireless chargeable devices.

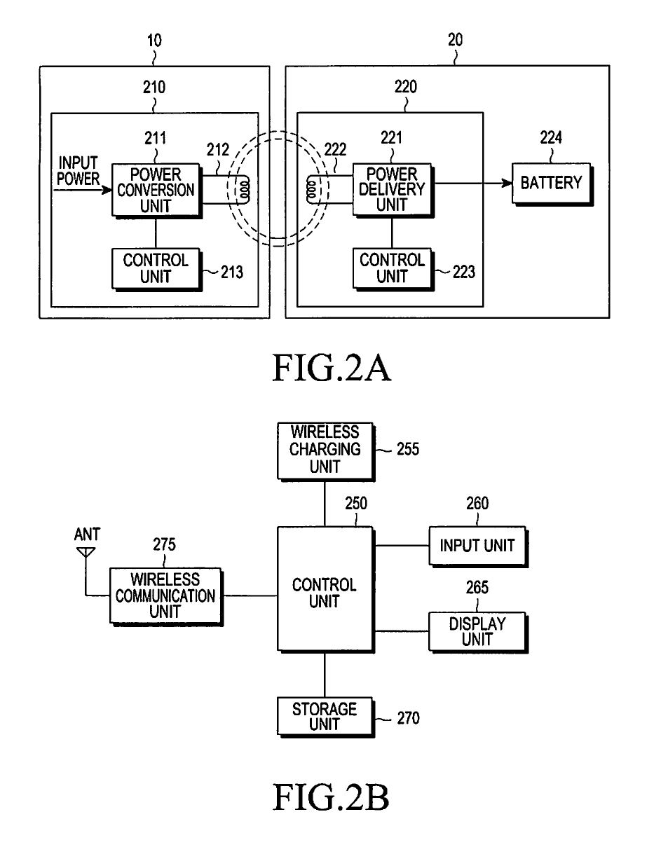

FIGS. 2A and 2B are diagrams illustrating the configuration of an electronic device that can perform wireless charging according to an embodiment of the present invention. FIG. 2A illustrates the configuration of a power transmitting unit 210 that performs wireless charging and a power receiving unit 220, and FIG. 2B illustrates the configuration of a wirelessly chargeable electronic device.

Referring to FIG. 2A, a device 10 that provides power through wireless charging includes the power transmitting unit 210. This power transmitting unit 210 includes a power conversion unit 211, a control unit 213, and a coil 212. As illustrated in FIG. 2A, the power conversion unit 211 is connected to the coil 212 to generate a magnetic field. The control unit 213 controls the power conversion unit 211 to supply the power to a power receiving device 20 up to a desired level. The power transmitting unit 210 may include several power conversion units 211.

The power receiving device 20 includes the power receiving unit 220. This power receiving unit 220 includes a power delivery unit 221, a control unit 223, and a coil 222. The power delivery unit 221 is connected to the coil 222 to deliver the power in a similar manner to the power transmitting unit 210 and the power conversion unit 211. A portable device generally includes one power receiving unit 220. The communication and control unit 223 operates to supply the power to a proper load connected to the power delivery unit 221. Generally, a charging battery may be a representative example of the load, and the power delivery unit 221 may be included in a case of the portable device or a battery 224.

A device for performing wireless charging may also include a wireless charging unit that includes the power transmitting unit 210 and the power receiving unit 220.

FIG. 2B illustrates the configuration of a wirelessly chargeable electronic device according to an embodiment of the present invention. The wirelessly chargeable electronic device includes a control unit 250, an input unit 260, a display unit 265, a storage unit 270, a wireless communication unit 275, and a wireless charging unit 255.

The input unit 260 is composed of a physical keypad, a keyboard, a mouse, a touch screen, and the like, and receives a user input.

The display unit 265 outputs the content to be displayed under the control of the control unit 250. In an embodiment of the present invention, the display unit 265 displays a charging state and whether the charging is completed when wireless charging is performed, and displays the charging result when the charging is completed.

The storage unit 270 stores information required to operate the wirelessly chargeable electronic device.

The wireless communication unit 275 performs mobile communication with another electronic device or the base station/server. In an embodiment of the present invention, the wireless communication unit 275 requests wireless charging from other electronic devices and receives a response to the request using near field communication, such as ZigBee, Bluetooth®, WiFi, Ultra-Wide Band (UWB), and the like.

The wireless charging unit 255 includes a power transmitting unit and a power receiving unit as illustrated in FIG. 2A to perform wireless charging.

The control unit 250 controls respective constituent elements of the wirelessly chargeable electronic device. In an embodiment of the present invention, the control unit 250 performs setting of the corresponding electronic device (a mode change) to a requesting electronic device if the charging is necessary, requests the charging from at least one electronic device, receives status information from the at least one electronic device that has received the charging request, selects a second electronic device based on the status information to receive the power supply, and performs wireless charging by receiving the power supplied from the selected at least one second electronic device.

The control unit requests charging from the at least one electronic device using the near field communication through the near field communication using one of ZigBee, Bluetooth®, wireless LAN, and UWB.

Status information includes information on whether wireless charging can be provided, and further includes at least one of a chargeable power amount, identification information of a wireless communication device, wireless charging service subscription information, and position information of the device.

Also, the control unit determines the wirelessly chargeable electronic device based on the status information, measures power transmission efficiencies between the first electronic device that has requested the charging and the wirelessly chargeable electronic devices if plural electronic devices can perform wireless charging, and selects the second electronic device for receiving the power supplied from the device having the high power transmission efficiency.

Also, the control unit operates to transmit the charging result information to a server for billing if wireless charging is completed.

On the other hand, if the electronic device receives the charging request, the control unit sets the electronic device to a supply electronic device, transmits status information to the electronic device that has requested the charging, and performs wireless charging by supplying the power to the electronic device that has requested the charging.

The status information that is transmitted to the electronic device that has requested the charging includes information on whether wireless charging can be provided, and further includes at least one of a chargeable power amount, identification information of a wireless communication device, wireless charging service subscription information, and position information of the wireless communication device.

Whether wireless charging can be provided is determined in consideration of whether the electronic device that has requested the charging has subscribed to a wireless charging service, whether the electronic device that has requested the charging can receive the power, and a remaining power amount of the supply electronic device.

Also, the control unit transmits a message for reporting cancellation of the wireless charging session and charging result information to a server for billing if the charging session is canceled before wireless charging is completed.

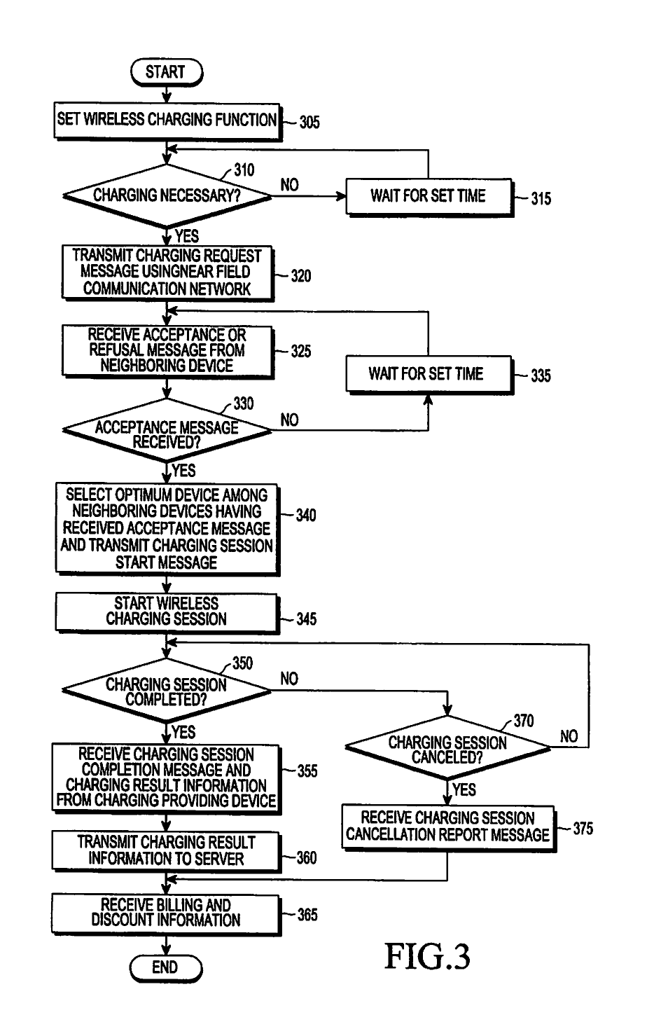

FIG. 3 is a diagram illustrating an operational flow of a charging request device during a wireless charging operation of a wireless communication device according to an embodiment of the present invention. Referring to FIG. 3, if a wireless communication device sets the wireless charging function in Step 305, the wireless communication device determines whether the charging is necessary by measuring the current power amount of the wireless communication device in Step 310. If in Step 310 it is determined that charging is not required, the wireless communication device proceeds to Step 315 to wait for a preset time, and then proceeds to Step 310 again.

If it is determined that the charging is necessary as a result of determination in Step 310, the wireless communication device is set to a requesting electronic device for the wireless charging, and proceeds to Step 320 to transmit a charging request message to other neighboring wireless communication devices or electronic devices that can provide the power using near field communication network.

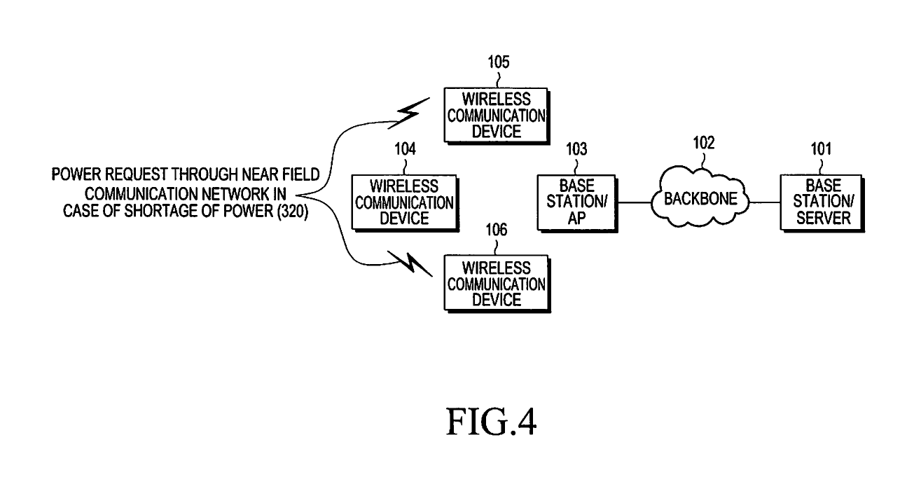

FIG. 4 is a diagram briefly illustrating a power request operation performed by a wireless communication device that is low on power during a wireless charging operation of a wireless communication device according to an embodiment of the present invention. As illustrated in FIG. 4, if a mobile communication device 104 is low on power and determines that the charging is necessary, the mobile communication device 104 transmits a charging request message to other neighboring wireless communication devices 105 and 106 using near field communication. The charging request message includes a necessary power amount, terminal identification information of the corresponding mobile communication device, and the like. Also, position information of the mobile communication device itself that is measured using GPS or AP may be transmitted.

In an embodiment of the present invention, the near field communication may be performed using near field communication network, such as ZigBee, Bluetooth®, wireless LAN, or UWB, and may be an arbitrary communication protocol that is possible on the wireless charging system.

Also, a device that receives the wireless charging request and performs wireless charging may be another wireless communication device that can perform wireless charging or any electronic device that can provide the power, such as a power station that is installed to perform wireless charging. In the same manner, although the wireless communication device that request wireless charging is illustrated in FIG. 3 as an example, all the electronic devices that can perform wireless charging can perform the same operation.

Next, in Step 325, the wireless communication device that has requested the charging receives responses to the request message from other neighboring wireless communication devices that have received the charging request message. This response message includes status information including whether the wireless communication device can provide wireless charging. For example, the response message may further include at least one of a chargeable power amount, identification information of a wireless communication device, wireless charging service subscription information, and position information of the wireless communication device.

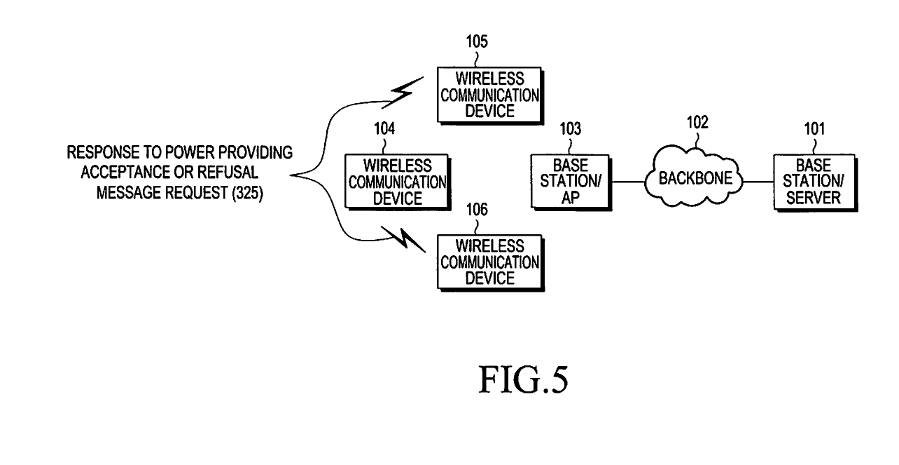

FIG. 5 is a diagram briefly illustrating an operation of receiving a response message to a power request during a wireless charging operation of a wireless communication device according to an embodiment of the present invention. As illustrated in FIG. 5, a wireless communication device 104 that has requested the charging receives an acceptance or refusal message in response to the charging request message transmitted in Step 320. If plural acceptance messages are received, the wireless communication device 104 measures the power transmission efficiencies between the devices that has received the acceptance messages and the wireless communication device that have requested wireless charging, and selects the device having the highest efficiency as the device that will perform the charging.

Next, in Step 330, the wireless communication device determines where there is at least one wireless charging acceptance message among the status information messages received as the responses to the charging request. If no acceptance message is received as a result of the determination in Step 330, the wireless communication device proceeds to Step 335 to wait for a preset time, and then proceeds to Step 325 again.

If at least one acceptance message is received as the result of the determination in Step 330, the wireless communication device proceeds to Step 340 to select a device from which the former device intends to receive the power among the neighboring communication devices that have accepted the charging request, transmits a charging session start message to the selected device, proceeds to Step 345 to receive a response to the charging session start message, and starts the wireless charging session.

On the other hand, the charging session start message may be included in the charging request message that is transmitted in 320, and the response to the charging request message may be included in the response to the charging session start message in Step 325.

Next, in Step 350, the wireless communication device determines whether the charging session is completed. If the charging session is not completed as a result of the determination in Step 350, the wireless communication device determines whether the charging session is canceled. If the charging session is not canceled, the wireless communication device proceeds again to Step 350. In Step 370, the session may be canceled if the two devices that perform the charging become far apart from each other before the charging is completed. The device that has provided the power informs the server that the session is canceled, and the wireless communication device receives a charging session cancellation report message from the server in Step 375 to proceed to Step 365. On the other hand, when near field communication is possible between two devices that perform wireless charging and the security is confirmed, the state where the charging session is canceled can be directly transferred without passing through the server.

If the charging session is completed as a result of the determination in Step 355, the wireless communication device receives a message for reporting the completion of the charging session and information on the charging result from the charging providing device. Next, in Step 360, the wireless communication device that has received the power transmits information on the charging result to the server.

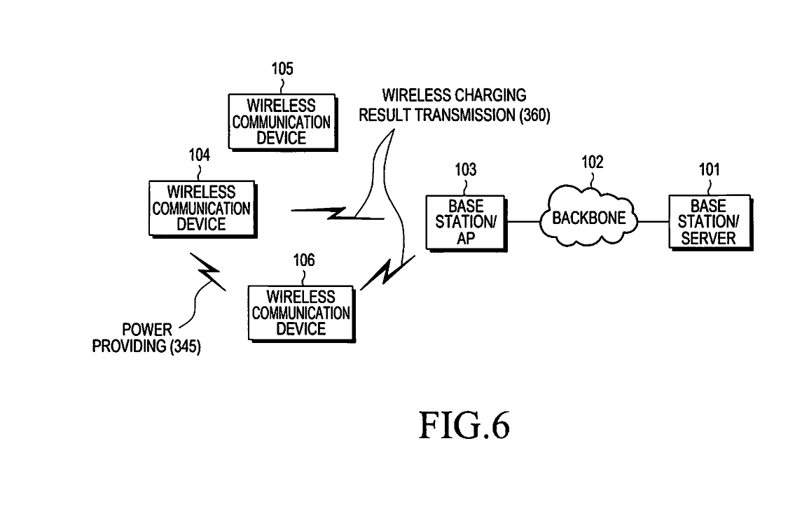

FIG. 6 is a diagram briefly illustrating an operation of transmitting a wireless charging result during a wireless charging operation of a wireless communication device according to an embodiment of the present invention.

As illustrated in FIG. 6, the wireless communication device 104 selects the device that will provide the power (wireless communication device 106 in FIG. 6) among the neighboring devices that have accepted the charging request, and receives the power from the selected communication device 106. Thereafter, if the charging is completed, the device 104 that has received the power and the device 106 that has supplied the power transmit the charging result to the base station/AP 103 to transmit the charging result to the server.

Next, in Step 365, the wireless communication device receives billing and discount information according to the charging result from the base station server 101 and ends the charging process.

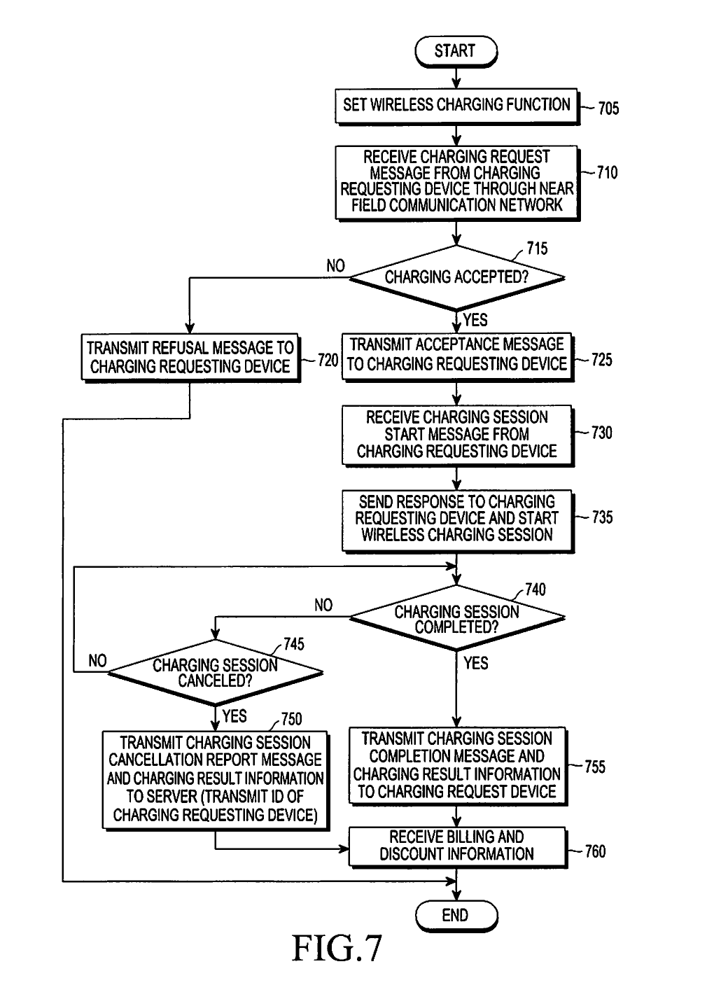

FIG. 7 is a diagram illustrating an operational flow of a charging providing device during a wireless charging operation of a wireless communication device according to an embodiment of the present invention.

Referring to FIG. 7, the charging providing device sets the wireless charging function in Step 705, and receives a charging request message from the charging requesting device in Step 710. The charging providing device that has received the charging request message is set to a supply electronic device for wireless charging in Step 715, confirms whether the charging requesting device (requesting electronic device) has subscribed to a wireless charging service and whether the charging requesting device can receive the power, and determines whether the power receiving is possible in consideration of a remaining power amount of the supply electronic device.

If the power receiving is impossible in Step 715, the charging providing device proceeds to Step 720, and transmits status information including a charging refusal message to the charging requesting device to end the process.

If the power receiving is possible in Step 715, the charging providing device proceeds to Step 725 and transmits the status information including a charging acceptance message that informs the charging requesting device that wireless charging is possible. Thereafter, if the charging session start message is received from the charging requesting device in Step 730, the charging providing device transmits a response to the charging session start message to the charging requesting device in Step 735, and starts the wireless charging session.

Thereafter, the charging providing device determines whether the charging session is completed in Step 740, and if the session is not completed as a result of determination in Step 740, the charging providing device determines whether the charging session is canceled. If the charging session is not canceled as a result of determination in Step 745, the charging providing device proceeds to Step 740 to continue the charging session, while if the charging session is canceled as a result of determination in Step 745, the charging providing device proceeds to Step 750, and transmits a message for informing the server that the charging session is canceled and the charging result to the server. The session may be canceled if the two devices that perform the charging become far apart from each other before the charging is completed. The charging providing device also transmits the identification information of the charging requesting device to the server.

If the charging session is completed in Step 740, the charging providing device proceeds to Step 755, and transmits a charging session completion message and charging result information to the charging requesting device. The charging providing device transmits the charging result information that includes identification information of the charging requesting device, a charging power amount, and the like. Then, in Step 760 the charging providing device receives information on the billing and discount according to the charging result from the server.

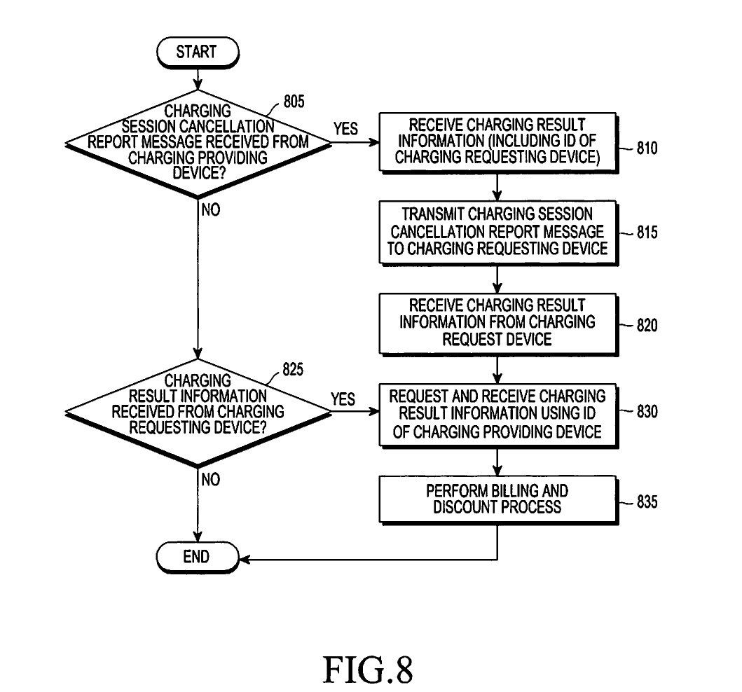

FIG. 8 is a diagram illustrating an operational flow of a server during a wireless charging operation of a wireless communication device according to an embodiment of the present invention.

Referring to FIG. 8, the server determines whether a charging session cancellation report message is received from the charging providing device in Step 805, and if the charging session cancellation report message is received, the server receives the charging result information including the Identification information (ID) of the charging requesting device from the charging providing device in Step 810. If the charging session cancellation report message is not received in Step 805, the server determines whether charging result information is received from the charging requesting device in step 825. If charging result information is not received from the charging requesting device in step 825 then the server ends the wireless charging operation. If charging result information is received from the charging requesting device in step 825 then the server proceeds to step 830 to receive the charging result information by requesting the charging result information using the ID of the charging providing device. In Step 815, the server transmits a message for informing the charging requesting device that the charging session is canceled using the identification information of the charging requesting device received in Step 810. In steps 810 to 815, the near field communication is possible between the charging requesting device and the charging providing device, and if security is guaranteed, the charging can be performed through direct exchange of mutual information between two devices without passing through the sever.

Thereafter, in Step 820, the server receives the charging result information from the charging requesting device. Then, in Step 830, the server receives the charging result information by requesting the charging result information using the ID of the charging providing device.

Thereafter, in Step 835, the server performs a billing and discount process. The server may discount the usage charges with respect to the power providing device according to the pre-engaged content in consideration of the charged amount, or may perform billing with respect to the power receiving device according to the pre-engaged content.

According to the present invention, an electronic device, for example, a wireless communication device can receive the power from other neighboring wirelessly chargeable electronic devices, for example, a power station or another wireless communication device by requesting wireless charging using the near field communication.

Accordingly, a user can wirelessly receive the power from another electronic device without anxiety about battery discharge. Also, another user who has provided the charging using the wireless communication device may receive a discount of charges, and a communication provider can make an additional profit such as acquisition of an intermediate commission.

Also, when searching for a neighboring wireless communication device that can provide the power or an electronic device such as a power station for providing the wireless charging service, the searching operation can be performed more simply using the near field communication network instead of the existing server or AP.

While the invention has been shown and described with reference to the embodiments thereof, various modifications may be made without departing from the scope of the invention. Accordingly, the scope of the invention is not defined by the above-described embodiments, but should be defined by the appended claims and their equivalents.

What is claimed is:

1. A bidirectional wireless charging method comprising:
performing a mode change to a requesting electronic device if charging is necessary;
requesting charging from at least one electronic device;
receiving status information from the at least one electronic device that has received the charging request;
selecting the electronic device based on the status information; and
performing charging by receiving power supplied from the selected at least one electronic device.

2. The bidirectional wireless charging method as claimed in claim 1, wherein, in the request to charge from the at least one electronic device, the at least one electronic device is requested to perform charging through near field communication.

3. The bidirectional wireless charging method as claimed in claim 2, wherein near field communication is performed using one of ZigBee, Bluetooth®, wireless LAN, and UWB.

4. The bidirectional wireless charging method as claimed in claim 1, wherein the status information includes information on whether wireless charging can be provided, and further includes at least one of a chargeable power amount, identification information of a wireless communication device, wireless charging service subscription information, and position information of the wireless communication device.

5. The bidirectional wireless charging method as claimed in claim 1, wherein selecting of the electronic device based on the status information comprises:
determining the electronic devices that can perform wireless charging by receiving the status information;
measuring power transmission efficiencies with the electronic devices that can perform wireless charging if plural electronic devices can perform wireless charging; and
selecting the electronic device having the highest power transmission efficiency as the electronic device from which the power is to be received.

6. The bidirectional wireless charging method as claimed in claim 1, wherein performing of the charging by receiving the power supplied from the selected at least one electronic device comprises:
transmitting a charging session start message to the selected at least one electronic device;
receiving a response to the charging session start message from the selected at least one electronic device; and
performing the charging by receiving the power from the selected at least one electronic device.

7. The bidirectional wireless charging method as claimed in claim 1, further comprising transmitting charging result information to a server if wireless charging is completed.

8. A bidirectional wireless charging method comprising:
performing a mode change to a supply electronic device if a charging request is received;
transmitting status information to an electronic device that has requested the charging; and
performing charging by supplying power to the electronic device that has requested the charging.

9. The bidirectional wireless charging method as claimed in claim 8, wherein, in performing of a mode change to a supply electronic device if a charging request is received, a mode change is performed to a supply electronic device if the charging request is received through near field communication.

10. The bidirectional wireless charging method as claimed in claim 9, wherein near field communication is performed using one of ZigBee, Bluetooth®, wireless LAN, and UWB.

11. The bidirectional wireless charging method as claimed in claim 8, wherein the status information includes information on whether wireless charging can be provided, and further include at least one of a chargeable power amount, identification information of a wireless communication device, wireless charging service subscription information, and position information of the wireless communication device.

12. The bidirectional wireless charging method as claimed in claim 11, wherein whether wireless charging can be provided is determined in consideration of whether the electronic device that has requested the charging has subscribed to a wireless charging service, whether the electronic device that has requested the charging can receive the power, and a remaining power amount of the supply electronic device.

13. The bidirectional wireless charging method as claimed in claim 8, wherein performing of the charging by supplying the power to the electronic device that has requested the charging comprises:
receiving a charging session start message from the electronic device that has requested the charging;
transmitting a response to the charging session start message; and
performing the charging by supplying the power to the electronic device that has requested the charging.

14. The bidirectional wireless charging method as claimed in claim 8, further comprising transmitting a message for reporting cancellation of the wireless charging session and charging result information to a server if the charging session is canceled before wireless charging is completed.

15. A bidirectional wireless charging apparatus comprising:
a wireless charging unit performing wireless charging;
a wireless communication unit performing near field communication;
a display unit displaying a charging state during wireless charging;
an input unit receiving a user input; and
a control unit performing a mode change to a requesting electronic device if charging is necessary, requesting charging from at least one electronic device, receiving status information from the at least one electronic device that has received the charging request, selecting the electronic device based on the status information, and performing charging by receiving power supplied from the selected at least one electronic device.

16. The bidirectional wireless charging apparatus as claimed in claim 15, wherein the request to charge by the control unit from the at least one electronic device is a request to charge from the at least one electronic device through near field communication.

17. The bidirectional wireless charging apparatus as claimed in claim 16, wherein near field communication is performed using one of ZigBee, Bluetooth®, wireless LAN, and UWB.

18. The bidirectional wireless charging apparatus as claimed in claim 15, wherein the status information includes information on whether wireless charging can be provided, and further includes at least one of a chargeable power amount, identification information of a wireless communication device, wireless charging service subscription information, and position information of the wireless communication device.

19. The bidirectional wireless charging apparatus as claimed in claim 15, wherein the control unit's selecting of the electronic device based on the status information includes determining the electronic devices that can perform wireless charging by receiving the status information, measuring power transmission efficiencies with the electronic devices that can perform wireless charging if plural electronic devices can perform wireless charging, and selecting the electronic device having the highest power transmission efficiency as the electronic device from which the power is to be received.

20. The bidirectional wireless charging apparatus as claimed in claim 15, wherein the control unit's performing of the charging by receiving the power supplied from the selected at least one electronic device includes transmitting a charging session start message to the selected at least one electronic device, receiving a response to the charging session start message from the selected at least one electronic device, and performing the charging by receiving the power from the selected at least one electronic device.

21. The bidirectional wireless charging apparatus as claimed in claim 15, wherein the control unit transmits charging result information to a server if wireless charging is completed.

22. The bidirectional wireless charging apparatus as claimed in claim 15, wherein the control unit performs a mode change to a supply electronic device if a charging request is received, transmits status information to an electronic device that has requested the charging, and performs charging by supplying power to the electronic device that has requested the charging.

23. The bidirectional wireless charging apparatus as claimed in claim 22, wherein the status information that is transmitted to the electronic device that has requested the charging includes information on whether wireless charging can be provided, and further includes at least one of a chargeable power amount, identification information of a wireless communication device, wireless charging service subscription information, and position information of the wireless communication device.

24. The bidirectional wireless charging apparatus as claimed in claim 23, wherein whether wireless charging can be provided is determined in consideration of whether the electronic device that has requested the charging has subscribed to a wireless charging service, whether the electronic device that has requested the charging can receive the power, and a remaining power amount of the supply electronic device.

25. The bidirectional wireless charging apparatus as claimed in claim 22, wherein the control unit's performing of the charging by supplying the power to the electronic device that has requested the charging includes receiving a charging session start message from the electronic device that has requested the charging, transmitting a response to the charging session start message, and performing the charging by supplying the power to the electronic device that has requested the charging.

26. The bidirectional wireless charging apparatus as claimed in claim 22, wherein the control unit transmits a message for reporting cancellation of the wireless charging session and charging result information to a server for billing if the charging session is canceled before wireless charging is completed.
